(19) United States
(12) Patent Application Publication
(10) Pub. No.: US 2012/0128576 A1
(43) Pub. Date: May 24, 2012

(54) POWER PLANT HAVING A CHEMICAL REACTION CYCLE

(76) Inventor: Hamid Reza Sadeghi, Wien (AT)

(21) Appl. No.: 13/383,234

(22) PCT Filed: Jul. 9, 2010
(86) PCT No.: PCT/AT2010/000255

§ 371 Date: Jan. 10, 2012

(30) Foreign Application Priority Data
Jul. 16, 2009 (AT) A 1121/2009

(51) Int. Cl. C01B 13/02; C01B 3/02

(52) U.S. Cl. 423/579; 423/648.1

(57) ABSTRACT

The present invention relates to a method for reacting and producing oxygen and hydrogen simultaneously, characterized in that the method comprises the following steps: a) reacting carbon with oxygen to form carbon dioxide, b) reacting carbon dioxide with phosphorus to form phosphorus pentoxide, c) reacting phosphorus pentoxide with calcium oxide and forming calcium phosphate, and d) reacting calcium phosphate with hydrogen to form calcium oxide as slag and phosphorus as white phosphorus and water as mixed cleaved atomic oxygen and later as molecular oxygen (O2) and hydrogen (2H2) separated from each other, and all products return to the cycle.

The present invention relates to a chemical reaction cycle for a power plant, wherein the process makes possible an environmentally-friendly and very economically favorable production of energy. The reaction process serves for producing a quantity of energy without producing carbon dioxide. The system utilizes oxygen and hydrogen as input materials for producing energy.

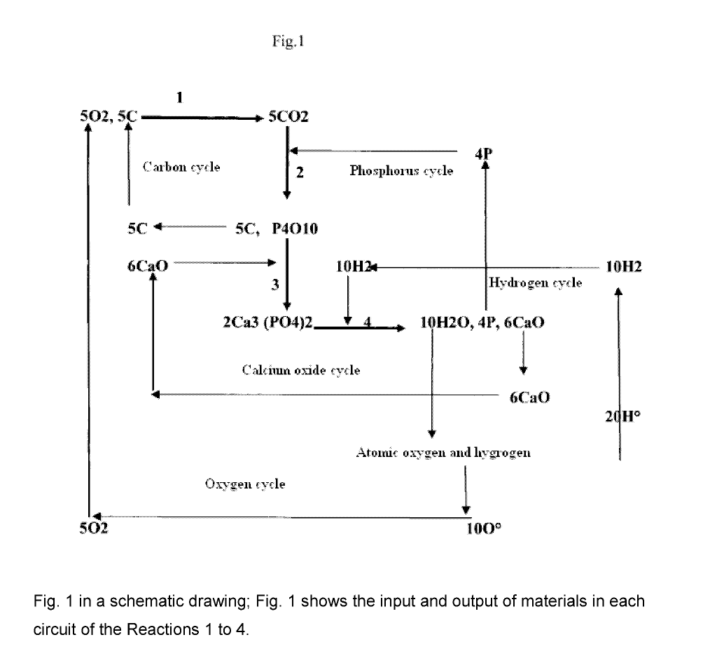

The invention relates to a chemical reaction process for a power plant. The process comprises a number of chemical reactions, 1 to 4. The cycle is shown theoretically in FIG. 1.

| | | |
|---|---|---|
| | oxygen, carbon | carbon dioxide |
| 1. | 5O₂ (g) + 5C(s) → | 5CO₂ (g) + E° Reaction 1 |
| | carbon dioxide, white | phosphorus pentoxide |
| | phosphorus | |
| 2. | 5CO₂ (g) + 4P(s) → | P₄O₁₀(s) + 5C(s) + |
| | Phosphorus pentoxide, | E° Reaction 2 |
| | calcium oxide | calcium phosphate |
| 3. | P₄O₁₀(s) + 6CaO(s) → | 2Ca₃(PO₄)₂(s) + E° Reaction 3 |
| | calcium phosphate, hydrogen | white phosphorus, calcium |
| | | oxide, water |
| 4. | 2Ca₃(PO₄)₂(s) + 10H₂(g) → | 4P(s) + 6CaO(s) + 10H₂O (g) + |
| | | E° Reaction 4 |

The reaction steps can be summed up and described by the
following reaction equation.

| | |
|---|---|
| 5. | 5O₂(g) + 10H₂(g) → 10H₂O (g) + E° Reaction 5 |
| | E° Reaction 5 = E° Reaction 1 + E° Reaction 2 + E° |
| | Reaction 3 + E° Reaction 4 |

The present invention thus in sum total relates to a method for the reaction between oxygen and hydrogen, hereby characterized in that it comprises the following steps:
Reaction of carbon with oxygen with the formation of carbon dioxide,
Reaction of carbon dioxide with phosphorus with the formation of phosphorus pentoxide and carbon. The products can be separated from one another by different boiling-point temperatures. Phosphorus pentoxide boils at 631 K and carbon at 4000 K.
Reaction of phosphorus pentoxide with calcium oxide with formation of calcium phosphate, and
Reaction of calcium phosphate with hydrogen with the formation of phosphorus; here the gaseous phosphorus at over 550 K is conducted into a tower for condensation and is sprayed therein with water; calcium oxide runs as slag at 3000 K, and the produced water exists at a temperature above 5000 K as atomic oxygen (2O°) and hydrogen)(2H°, which are separated by a number of separating methods with phase diagram treatment, e.g., several separating methods can be used: centrifuging method, diffusion method, dissociation methods, distillation method under pressure, and for paramagnetic property with electrical field. And oxygen O₂ and hydrogen H₂ are brought back to the cycle once more as molecules; these separating method help us by decreasing costs tremendously and are most important:
Producing fuel (H₂) at the same time without producing CO₂, and we utilize the property of Reaction 4, since it creates cleaved hydrogen, and this allows us to obtain produced energy that is completely clean and would be economically favorable.

Preferably, the phosphorus is introduced as white phosphorus.

Preferably, the reaction of calcium phosphate with hydrogen is conducted by introduction of electrical power with the help of solar energy.

Preferably, the reaction of calcium phosphate with hydrogen to the formed phosphorus is carried out in a condensation tower.

Preferably, the water formed is taken up in the form of atomic gas 2O and 2H and separated later as molecules.

Preferably, the carbon is introduced in the form of coke (graphite).

Preferably, the reaction of calcium phosphate and hydrogen is carried out in an electro-solar reactor at least 5000 K.

The method is based on current knowledge with respect to thermodynamics and inorganic chemistry. It is shown in the following how the course of the process functions. A clean and economically favorable energy production was made possible.

The invention thus relates to a chemical cycle for a power plant, wherein the power plant produces environmentally-friendly energy by the chemical reactions. It is shown that energy can be ideally produced by the chemical reaction. And it would be possible by the cycle process to now control the explosion reaction with thermal efficiency; with definitions Tₘᵢₙ and Tₘₐₓ for the cycle, a thermal efficiency is assumed for the entire process, and by means of a temperature control, a still higher ηth thermal efficiency can be achieved by the reaction, and other advantages result due to the cycle process: thus a huge production of energy can be made possible under 1200 K; in contrast, with the simple explosion reaction, energy production is very difficult under this critical situation, with extremely high pressure, at over 5500 K, and with this enormous energy production ΔH° Reaction 5=−2420 KJ/mol in a very short time, since on a technical basis, energy is produced under such a critical situation that a shock wave is triggered, which spreads via the speed of sound. An explosive heats up in a simple explosion reaction (Reaction 5) up to a temperature of about 6000 K and the reaction spreads extremely rapidly. Such uncontrollable reactions are called detonation. But the cycle here changes these explosion-type reactions to energy production, which are mild, moderate and calm, instead of explosion-like. The discharge of heat occurs at under 1200 K instead of over 6000 K, and the heat input is at 5500 K, which, on a technical basis, is a great advantage for us in that heat is introduced at a high temperature and is discharged at a low temperature.

It was also proposed to bring the products of the reactions back to their initial reaction. The advantage therein is to greatly reduce costs for the yield and to create an environmentally-friendly production.

The method is based on thermodynamic and inorganic investigations of the chemical reaction process.

The process according to the invention is illustrated by the following simplifications:

The gaseous matter in the reactions contains the ideal gas. For the case when pressure and temperature are constant, and no other work is performed except for volume work, the relationship dG=dH−SdT shows that G as a function is proportionally dependent on P and T. The chemical process is shown, for example, in the drawing. FIG. 1 shows the chemical reaction process in a schematized drawing.

According to the example of embodiment shown, the energy of the power plant is produced from the chemical reaction.

### EXAMPLES

In the following examples, energy is produced for a power plant by chemical reaction processes of oxygen and hydrogen, known in and of themselves, in a series of reactions, in which heat is introduced or discharged. a) The thermodynamic component (ΔH, ΔS, ΔG) is calculated for each stage of the reactions and for the comparative reaction. b) In a system in which oxygen (O₂) is introduced into the system at 10 kg/s, the production and energy yield as well as the mass flow are calculated for all components that participate in the reaction, c) and the thermal efficiency ηth for the entire cycle. By means of a number of chemical reactions, five molecules of oxygen O₂ and ten molecules of hydrogen H₂ are reacted during the process at high temperature (5000° C.) and ten molecules of water are formed as atomic oxygen (2O) and hydrogen (2H) with these thermodynamic properties. And these are once more brought back into the process.

### Example 1: a)

1. Combustion of coke temperatures [sic] and oxygen O₂, discharge of heat

5O₂(g)+5C(s)→5CO₂(g)+E° Reaction 1

### ΔH° Reaction 1=−1970 KJ/mol

ΔS° Reaction 1=15 J/mol. K

### ΔG° Reaction 1=−1970 KJ/mol

The reaction is exothermic, and also the entropy is favorable, and ΔG° Reaction 1 is negative; the reaction is spontaneous at all temperatures.

2. Combustion of white phosphate* and carbon with exclusion of oxygen (O₂) at high temperatures; phosphorus pentoxide is formed, heat discharge.

5CO₂(g)+4P(s)→P₄O₁₀(s)+5C(s)+E° Reaction 2

### ΔH° Reaction 2=−1040 KJ/mol

ΔS° Reaction 2=−852 J/mol. K sic; white phosphorus?—Translator's note.

### ΔG° Reaction 2=−756 KJ/mol

The reaction is favorably exothermic due to the enthalpy, but is hindered by the entropy; it freely proceeds only at temperatures below T=ΔH° Reaction 2/ΔS° Reaction 2=1200 K. The reaction is spontaneous.

3. The formed phosphorus pentoxide is reacted with calcium oxide at high temperatures and calcium phosphate is formed; phosphorus pentoxide is added to burnt lime (CaO)(s) and a type of slag is formed; heat discharge.

P₄O₁₀(s)+6CaO(s)→2Ca₃(PO₄)₂(s)+E° Reaction 3

### ΔH° Reaction 3=−1422 KJ/mol

ΔS° Reaction 3=15 J/mol. K

### ΔG° Reaction 3=−1426 KJ/mol

The reaction proceeds like Reaction 1 and is spontaneous.

4. Phosphorus is produced by heating and reacting a mixture of calcium phosphate (Ca₃(PO₄)₂) and hydrogen at very high temperatures in an electroreactor, heat discharge.

2Ca₃(PO₄)₂(s)+10H₂(g)→4P(s)+6CaO(s)+10H₂O(g)+E° Reaction 4

### ΔH° Reaction 4=2012 KJ/mol

ΔS° Reaction 4=377 J/mol. K

### ΔG° Reaction 4=1862 KJ/mol

The reaction is unfavorably endothermic due to the enthalpy, but favorable due to the entropy; it is spontaneous above T=ΔH° Reaction 4/ΔS° Reaction 4=5300 K.

Reaction 4 requires a good deal of electrical energy so that the thermodynamic components are adapted to one another in the process. The phosphate escapes from the electroreactor as vapor in the form of molecules* and is collected under water as white phosphorus (P) in a condensation tower, and the formed water is produced in the state of mixed molecules and some atomic oxygen and hydrogen above 2500 K; depending on the pressure, water is cleaved into hydrogen and oxygen molecules. This process is called thermolysis of water. The phosphorus . . . in the form of 4P molecules?—Translator's note.
Thermolysis: at above 2500 K

2H₂O(l)→2H₂(g)+O₂(g)
Homolysis: at a temperature of up to 5000 K, the molecules of oxygen and hydrogen are up to 95.5% cleaved to the atomic state

2H₂→4H°

O₂→2O°

The mixed atomic oxygen (2O°) and hydrogen)(4H° are separated from one another by a separating method.

And once more these are returned to the cycle and the calcium oxide is introduced to the cycle system as a readily melting slag at 3000 K.

5. The entire reaction process can be defined by one reaction, heat discharge.

5O₂(g)+10H₂(g)→10H₂O(g)+E° Reaction 5

### ΔH° Reaction 5=−2420 KJ/mol

ΔS° Reaction 5=−445 J/mol. K

### ΔG° Reaction 5=−2290 KJ/mol

The thermodynamic conditions do not depend on the route by which the product is formed, but rather the same beginning and the same end are the deciding factors.
ΔH° Reaction 5=ΔH° Reaction 4+ΔH° Reaction 3+ΔH° Reaction 2+ΔH° Reaction 1

### Example 2: b)

The invention makes it possible to provide environmentally-friendly economically and favorable production of energy.

5O₂(g)+5C(s)→5CO₂(g)+E° Reaction 1

If the mass flow of O₂ is adjusted to 10 kg/s→833.4 mol/s O₂, 833.4 mol/s CO₂ or 36.7 kg/s CO₂.

5CO₂(g)+4P(s)→P₄O₁₀(s)+5C(s)+E° Reaction 2

666.7 mol/s 4P or 20.7 kg/s P₄
166.7 molts P₄O₁₀ or 47.4 kg/s P₄O₁₀

P₄O₁₀(s)+6CaO(s)→2Ca₃(PO₄)₂(s)+E° Reaction 3

1000 molts CaO or 56 kg/s CaO
333.4 molts Ca₃(PO₄)₂ or 103.4 kg/s 2Ca₃(PO₄)₂

2Ca₃(PO₄)₂(s)+10H₂(g)→4P(s)+6CaO(s)+10H₂O(g)+E° Reaction 4

1666.7 molts H₂ or 3.4 kg/s H₂
1666.7 mol/s H₂O or 30 kg/s H₂O.

### Example 3: b)

In FIG. 1 the process circuits are shown schematically. Individual stages are characterized by reference numbers; process flow (1-2) is a combustion reaction, wherein carbon dioxide (CO₂) is formed from oxygen (O₂) and carbon (C) and energy is produced up to −1970 KJ/mol and at any temperature. Process flow (2-3) shows an oxidation reaction between white phosphorus (P) and carbon dioxide (CO₂) with exclusion of oxygen (O₂), whereby phosphorus pentoxide (P₄O₁₀) and carbon (C) are formed. The products can be separated from one another by different boiling-point temperatures. Phosphorus pentoxide boils at 600 K and carbon at 4000 K. The reaction produces energy freely up to −1040 kJ/mol at temperatures below 1200 K. In process flow (3-4), phosphorus pentoxide (P₄O₁₀) reacts with calcium oxide (CaO), whereby calcium phosphate Ca₃(PO₄)₂ is formed and energy of −1422 KJ/mol is produced freely at any temperature. The formed phosphorus pentoxide (P₄O₁₀) is converted to slag with burnt lime (CaO) and phosphorite (Ca₃(PO₄)₂). Process flow (4-5) is an endothermic reaction. In industrial production, phosphate* is produced by heating a mixture of calcium phosphate, coke and silicon dioxide (quartz sand) in an electroreactor to at least 1500° C.

In Reaction 4, the thermodynamic property of the process shows that a high temperature up to over 5000 K is required; thus the products of the process, such as phosphorus (P) are collected in a condensation tower under water as white phosphorus (P), and the formed water in the state of mixed, cleaved atomic oxygen (2O) and sic; phosphorus?—Translator's note. hydrogen (4H), which are later separated from one another as molecules of oxygen (O₂) and hydrogen (2H₂), and are once more introduced into the cycle; CaO is produced as slag at 3000 K. And this is re-introduced into the cycle.

### For Reaction 1:

5O₂(g)+5C(s)→5CO₂(g)+E° Reaction 1

P Reaction 1=mO₂. ΔH° Reaction 1=328 MW or

### P Reaction 1=mC. ΔH° Reaction 1=328 MW

### For Reaction 2:

5CO₂(g)+4P(s)→P₄O₁₀(s)+5C(s)+E ° Reaction 2

P Reaction 2=mp. ΔH° Reaction 2=173 MW
P Reaction 2=mCO₂. ΔH° Reaction 2=173 MW

### For Reaction 3:

P₄O₁₀(s)+6CaO(s)→2Ca₃(PO₄)₂(s)+E° Reaction 3

P Reaction 3=mP₄O₁₀. ΔH° Reaction 3=237 MW
P Reaction 3=mCaO. ΔH° Reaction 3=237 MW

### For Reaction 4:

2Ca₃(PO₄)₂(s)+10H₂(g)→4P(s)+6CaO(s)+10H₂O(g)+E° Reaction 4

P Reaction 4=mCa₃(PO₄)₂. ΔH° Reaction 4=335 MW
P Reaction 4=mH₂. ΔH° R4=335 MW
The total value: 328+173+237−335=403 MW
For Reaction 5 (the comparative process):

5O₂(g)+10H₂(g)→10H₂O(g)+E° Reaction 5

P Reaction 5=mH₂. ΔH° Reaction 5=403 MW
P Reaction 5=mO₂. ΔH° Reaction 5=403 MW
If O₂ is adjusted to 10 kg/s, 403 MW of energy are produced.

c) The thermal efficiency for the entire cycle is thus defined by Tₘₐₓ, the highest temperature and Tₘᵢₙ, the lowest temperature of the cycle:

ηth=1−Tₘᵢₙ/Tₘₐₓ=1−1200/5300=0.77 or 77% which is the normal theoretical value of the thermal efficiency for the cycle; however, in practical terms, the Tₘₐₓ and Tₘᵢₙ can be set still higher and still lower than the values (5300 K, 1200 K),

e.g., Reactions 1 and 2 and 3 can run at 1000 K and reach to above 6000 K by means of the electro-solar rector, and the thermal efficiency will be high, up to:

ηth=1−Tₘᵢₙ/Tₘₐₓ=1−1000/6000=0.84 or 84% which means that the ηth is higher, the slower the heat discharge and the more rapid the heat input.

1. A method for reacting and at the same time producing oxygen and hydrogen, hereby characterized in that
it comprises the following steps:
Reaction of carbon with oxygen with the formation of carbon dioxide,
Reaction of carbon dioxide with phosphorus with the formation of phosphorus pentoxide and carbon,
Reaction of phosphorus pentoxide with calcium oxide with formation of calcium phosphate, and
Reaction of calcium phosphate with hydrogen with formation of calcium oxide as slag and phosphorus, water as cleaved gases hydrogen and oxygen.

2. The method according to claim 1, further characterized in that the phosphorus is introduced as white phosphorus.

3. The method according to claim 1, further characterized in that the reaction of calcium phosphate with hydrogen is conducted by introduction of electrical power or with solar power.

4. The method according to claim 1, further characterized in that in the reaction of calcium phosphate with hydrogen, the phosphorus that is formed is collected in a condensation tower under water.

5. The method according to claim 1, further characterized in that the water that is produced in the form of cleaved gases as (O₂) and (2H₂) are separated from one another and introduced into the cycle.

6. The method according to claim 1, further characterized in that carbon is introduced in the form of coke (graphite).

7. The method according to claim 1, further characterized in that the reaction of calcium phosphate and hydrogen is carried out in an electroreactor or by means of a solar reactor at least 5000° C.
